(19) United States
(12) Patent Application Publication
(10) Pub. No.: US 2012/0306162 A1
(43) Pub. Date: Dec. 6, 2012

(54) METAL SEAL HAVING AN INSERT THAT IS NOT RESISTANT TO EXHAUST GAS

(76) Inventors: Bartosz Gadomski, Burscheid (DE); Manfred Klinner, Troisdorf (DE)

(21) Appl. No.: 13/577,501

(22) PCT Filed: Oct. 14, 2010
(86) PCT No.: PCT/EP10/65415

§ 371 Date: Aug. 7, 2012

(30) Foreign Application Priority Data
Feb. 8, 2010 (DE) 10 2010 001 660.8

(51) Int. Cl. F02F 11/00

(52) U.S. Cl. 277/592

(57) ABSTRACT

A gasket for sealing off between two components of the exhaust line of a combustion engine includes an upper spring-elastic metal layer, a lower spring-elastic metal layer and an insert which is arranged between the upper and the lower metal layer. The gasket has at least one through-opening, and the upper and the lower layer on the sealing surface each have at least one bead which surrounds the at least one though-opening. The upper and the lower metal layers in the region adjoining the at least one through-opening are positively or materially interconnected.

The present invention relates to a metal gasket with an insert, which is not resistant to exhaust gases, in particular an exhaust gasket for two components of the exhaust line of a combustion engine that have to be sealed against each other.

Generic metal gaskets are employed in the region of the exhaust line. They comprise two metallic layers, each of which form a sealing surface to the components to be sealed. As thermal barrier between the sealing surfaces, a fibre or soft material insert is used. It must be noted that the insert does not come in contact with exhaust gases, since it is not exhaust gas resistant.

With known gaskets of this type, a metal layer of the gasket is folded over through the gasket in the region of the exhaust gas passage. Because of this, an overlap of the two metal layers occurs, which protects the insert from exhaust gases. The increase of the thickness of the gasket in the region of the overlap leads to a high local surface pressure, as a result of which the tightness of the gasket is achieved. However, a consequence of the high surface pressure are deformations on the component flanges.

It is therefore the object of the present invention to provide an improved gasket, wherein the tightness remains guaranteed without causing deformations on the component flanges in the process. In addition, the protection of the insert from exhaust gases is ensured through a gasket proposes according to the invention.

According to a first aspect of the invention, a gasket for sealing between two components of the exhaust line of a combustion engine is provided, comprising:
an upper spring-elastic metal layer;
a lower spring-elastic metal layer; and an insert, which is arranged between the upper and the lower metal layer; wherein
the gasket comprises at least one through-opening;
the upper and the lower metal layer on the sealing surface each comprise at least one bead, which encloses the at least one through-opening; and
the upper and the lower metal layer are positively or materially interconnected in the region adjoining the at least one through-opening.

In order to avoid the high local surface pressures of conventional gaskets, beads are stamped into the steel layers of the gasket. These assume the sealing performance instead of a local increase of the thickness through folding over of metal layers. Because of the necessary spring-elastic properties of the beads, a material with adequate spring-elastic properties has to be selected for the metal layers, for example spring steel.

However, through these properties of the metal layers folding-over in the region of the gas channel is only conditionally possible, since these would not securely retain their shape. For this reason, other measures are necessary for protecting the insert. According to the invention, it is therefore proposed to realise a positive or material connection on the exhaust gas side of the gasket between the upper and the lower metal layer.

Because of this, the insert is protected from the effect of exhaust gases, while the beads on the sealing surfaces of the gasket achieve an improved sealing effect, without deforming the component flanges in the process. Since the beads are more elastic than the conventional thickened portions through folding over, a higher durability of the gasket can also be assumed. Minor position changes of the component flanges relative to each other can be better compensated.

According to an embodiment, the upper and the lower metal layer are positively or materially interconnected in the edge region facing the through-opening.

Because of this, the insert can also be sealed against the outside of the gasket.

According to an embodiment, the upper and the lower metal layer are welded together in the region adjoining the through-opening. The welding can be effected through spot welding or through continuous welding.

According to an embodiment, the upper and the lower metal layer are positively interconnected in the edge region facing away from the through-opening. Alternatively, welding can also be provided here.

According to an embodiment, the insert comprises a soft material layer or a fibre insert.

According to an embodiment, the upper and the lower metal layer comprise spring steel layers.

According to an embodiment, the upper and the lower metal layer each comprise two beads.

According to an embodiment, the beads in the upper and the lower metal layer are full beads or half beads.

According to an embodiment, the at least one bead in the upper metal layer points in the same direction as the at least one bead in the lower metal layers. In an alternative embodiment, the at least one bead in the upper metal layer points in the other direction to that of the at least one bead in the lower metal layer.

According to an embodiment, the gasket comprises a metal intermediate layer between the insert and the upper or the lower metal layer.

According to an embodiment, the metal intermediate layer has the same number and type of beads as the adjoining upper or lower metal layer, and the arrangement of the bead(s) of the metal intermediate layer is the mirror image with respect to the adjoining upper or lower metal layer.

### BRIEF DESCRIPTION OF THE DRAWING

FIG. 1 shows a profile cross section of a first embodiment of the gasket according to the invention;

FIG. 2 shows a profile cross section of a second embodiment of the gasket according to the invention;

FIG. 3 shows a profile cross section of third embodiment of the gasket according the invention; and

FIG. 4 shows a profile cross section of a fourth embodiment of the gasket according to the invention.

Here and in the following description, only one profile cross section of the gasket is shown in each case, wherein the exhaust gas side of the gasket is located on the right-hand side of the Figure. The outer edge of the gasket in each case is located on the left-hand side of the Figure. The profile cross section of the entire gasket surrounds the at least one through-opening in a closed manner. The sealing surfaces for contacting the flanges of the components to be sealed (not shown in either case) in this case and in the following are located at the top and bottom in the Figure.

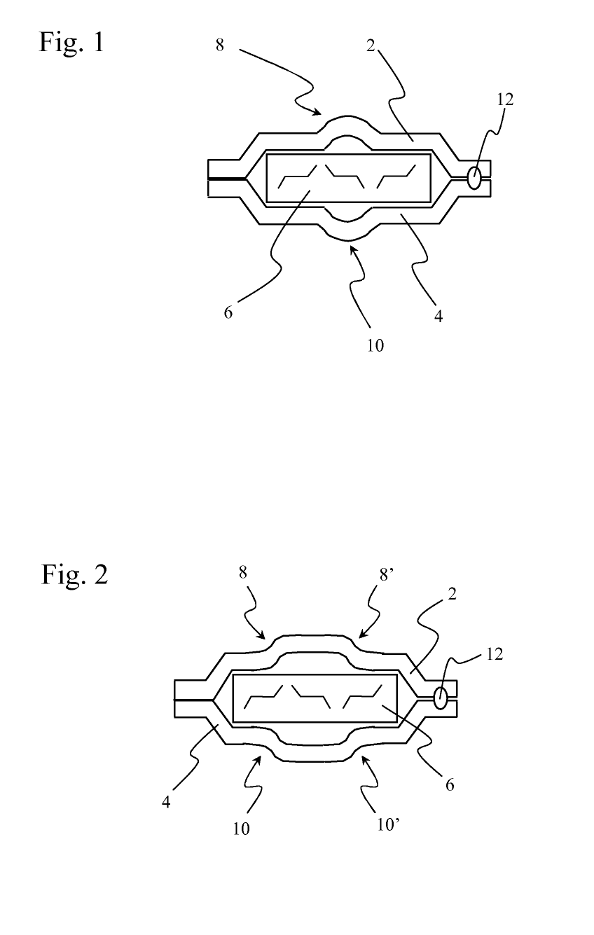

FIG. 1 shows a first embodiment of the gasket according to the invention. It comprises a first or upper metal layer 2, a second or lower metal layer 4, and an insert 6, which is arranged between the upper and lower metal layer 2, 4. The upper metal layer 2 comprises a bead 8 on the sealing surface, which in this embodiment is a full bead. Analogously, the lower metal layer 4 comprises a full bead 10 on its sealing surface.

The insert 6, which for example can be a soft material layer or fibre insert, is located between the upper and lower metal layer 2, 4. In order to protect the insert 6 from the effect of exhaust gases, the upper and the lower metal layer 2, 4 are interconnected on the exhaust gas side through a welded connection 12.

FIG. 2 shows a second embodiment of the gasket according to the invention. It comprises substantially the same elements as the gasket from FIG. 1, wherein in the embodiment shown here the individual full beads on the sealing surfaces of the upper and the lower metal layer 2, 4 are each replaced with two half beads 8, 8′ and 10, 10′ respectively. Because of this, a widened sealing zone is achieved, as a result of which the sealing effects can be improved. In the shown embodiment, the sealing line is substantially arranged in the middle.

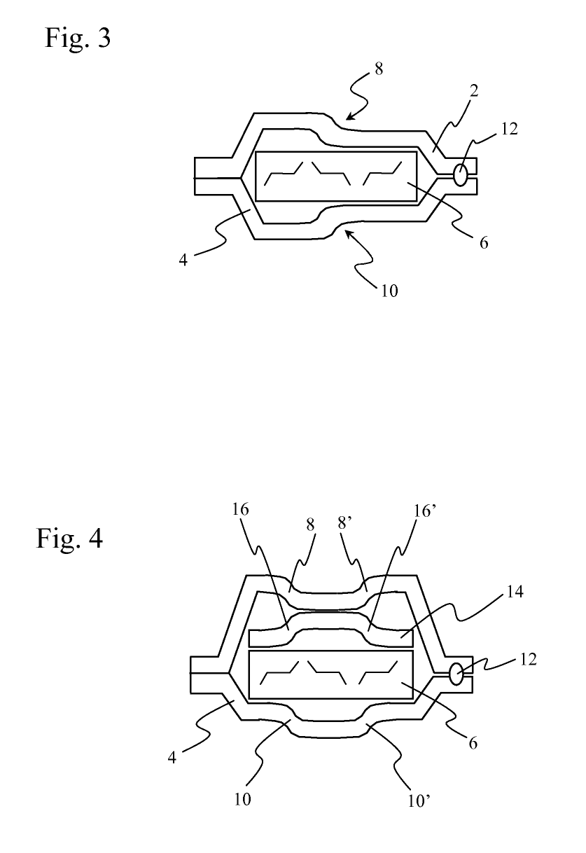

FIG. 3 shows a third embodiment of the gasket according to the invention. It substantially comprises the same elements as the gasket from FIG. 1, wherein in the embodiment shown here the individual full beads on the sealing surfaces of the upper and the lower metal layer 2, 4 are each replaced with an individual half bead 8 and 10 respectively. Similar to the embodiment from FIG. 2, a widened sealing zone is achieved by this, wherein these compared to FIG. 2 are not arranged in the middle, but are displaced in the direction of the outer edge of the gasket, In alternative embodiments (not shown), the wide sealing zone formed by the respective half beads can instead also be displaced in the direction of the exhaust gas side of the gasket.

FIG. 4 shows a third embodiment of the gasket according to the invention. It substantially comprises the same elements as the gasket from FIG. 2, wherein in this case the arrangement of the metal layers 2, 4 is not in mirror image as with the embodiments from FIGS. 1-3, but the same. In other words, the beads in the metal layers 2, 4 in this case do not point in opposite directions as in FIGS. 1-3, but in the same, Through the arrangement, instead of the one wide sealing zone, two wide sealing zones each in the direction of the outer or exhaust gas-sided edge of the gasket are created.

In addition, a metal intermediate layer 14 is arranged in this embodiment between the upper metal layer 2 and the insert 6 (in alternative embodiments which are not shown, the metal intermediate layer 14 can also be arranged between the lower metal layer 4 and the insert 6). Compared with the metal layer 2, the metal intermediate layer 14 has the same type and number of beads (in this case two half beads 16, 16′), The arrangement of the beads 16, 16′ mirror image to the beads 8, 8′ in the metal layer 2.

Through this arrangement, the insert 6 at its edges is additionally held securely between metal intermediate layer 14 and metal layer 4. On the one hand, the metal layer 2 during uneven loading can roll off between metal layer 2 and metal intermediate layer 14 via the middle contact surface. On the other hand, pressure loads on the upper sealing surface can be more easily passed on through the likewise springy metal intermediate layer 14. The metal intermediate layer 14 thus increases the elasticity and adaptability of the upper sealing surface of the gasket.

With gaskets according to the invention it is preferred that the bead(s) in each case are arranged on top of one another, as in the embodiments of FIGS. 1-3. Alternatively it is preferred that the arrangement of the bead(s) in upper and lower metal layer is symmetrical at least relative to the middle of the gasket (as in the embodiment from FIG. 4), in order to prevent tilting of the profile of the gasket.

According to the inventions, combinations of the shown types, quantities and arrangements of the beads in upper and lower metal layer are possible. Here, type, quantity and arrangement of the bead(s) in the respective metal layers are also possible independently of each other. For example, (a) half bead(s) can be provided in the upper metal layer, and (a) full bead(s) in the lower one, and vice versa.

With gaskets according to the present invention the tightness is ensured, wherein the deformation of component flanges does not occur or is at least clearly reduced. The insert is securely protected from the effects of exhaust gas.

1. A gasket for sealing between two components of the exhaust line of a combustion engine, comprising:
an upper spring-elastic metal layer;
a lower spring-elastic metal layer; and
an insert, which is arranged between the upper and the lower metal layer; wherein
the gasket comprises at least one through-opening;
the upper and the lower metal layer each comprise at least one bead on the sealing surface, which encloses the at least one through-opening; and
the upper and the lower metal layer are positively or materially interconnected in the region adjoining the at least one through-opening.

2. The gasket according to claim 1, wherein the upper and the lower metal layer in the edge region facing the through-opening are positively or materially interconnected.

3. The gasket according to claim 1 or 2, wherein the upper and the lower metal layer are welded together in the region adjoining the through-opening.

4. The gasket according to wherein the welding comprises a spot weld.

5. The gasket according to claim 3, wherein the welding comprises a continuous weld.

6. The gasket according to any one of the claims 1 to 5, wherein the upper and the lower metal layer are positively interconnected in the edge region facing the through-opening.

7. The gasket according to any one of the claims 1 to 6, wherein the insert comprises a soft material layer or a fibre insert.

8. The gasket according to any one of the claims 1 to 7, wherein the upper and the lower metal layer comprise spring steel layers.

9. The gasket according to any one of the claims 1 to 8, wherein the upper and the lower metal layer each comprise two beads.

10. The gasket according to any one of the claims 1 to 9, wherein the beads in the upper and the lower metal layer are full beads.

11. The gasket according to any one of the claims 1 to 9, wherein the beads in the upper and the lower metal layer are half beads.

12. The gasket according to any one of the claims 1 to 10, wherein the at least one bead in the upper metal layer points in the same direction as the at least one bead in the lower metal layer.

13. The gasket according to any one of the claims 1 to 11, wherein the at least one bead in the upper metal layer points in the other direction to that of the at least one bead in the lower metal layer.

14. The gasket according to any one of the claims 1 to 13, wherein the gasket between the insert and the upper or the lower metal layer comprises a metal intermediate layer.

15. The gasket according to claim 14, wherein the metal intermediate layer has the same number and type of beads as the adjoining upper or lower metal layer, wherein the arrangement of the bead(s) of the metal intermediate layer is in mirror image relative to the adjoining upper and lower metal layer.
